(19) United States
(12) Patent Application Publication
(10) Pub. No.: US 2019/0337271 A1
(43) Pub. Date: Nov. 7, 2019

(54) REINFORCED POLYPROPYLENE/MICRONIZED TIRE RUBBER POLYMER COMPATIBLE WITH STRUCTURAL FOAM MOLDING PROCESS

(71) Applicant: Ford Global Technologies, LLC, Dearborn, MI (US)

(72) Inventors: Talat Karmo, Waterford, MI (US); Alper Kiziltas, Sarikamis (TR); Paul Kenneth Dellock, Northville, MI (US); Stuart Salter, White Lake, MI (US); Richard Gall, Ann Arbor, MI (US)

(73) Assignee: Ford Global Technologies, LLC, Dearborn, MI (US)

(21) Appl. No.: 15/971,584

(22) Filed: May 4, 2018

(51) Int. Cl. B32B 27/06; B32B 5/18; B32B 27/32; B32B 27/18

(52) U.S. Cl. CPC B32B 27/065; B60R 13/0815; B32B 27/32; B32B 27/18; B32B 2262/101; B32B 2305/70; B32B 2262/106; B32B 2307/3065; B32B 2307/402; B32B 2307/546; B32B 2307/72; B32B 2307/558; B32B 2266/104; B32B 2605/003; B32B 2307/102; B32B 5/18

(57) ABSTRACT

A composite material is provided that includes a polypropylene material, a rubber material, a heat stabilizer in an amount between 0.25 wt. % and 3.0 wt. %, a coupling agent in an amount between 1.0 wt. % and 5.0 wt. %, and reinforcements in an amount between 5.0 wt. % and 40 wt. %. The polypropylene material is a recycled polypropylene material in an amount between 50 wt. % and 85 wt. %, while the rubber material is a recycled tire rubber material in an amount between 2.0 wt. % and 30 wt. %. The reinforcements may include fibers of glass, carbon, and recycled carbon fibers. Other forms of the composite material further include a flow enhancer in an amount between 0.01 wt. % and 2.0 wt. %.

### FIELD

The present disclosure relates to polypropylene composite materials and methods of forming parts from such materials with a structural foam molding process.

### BACKGROUND

The statements in this section merely provide background information related to the present disclosure and may not constitute prior art.

Fuel efficiency has been a motivating force behind vehicle design in recent years and will likely continue in the foreseeable future. As such, reducing the weight of the vehicle, improving aerodynamics, and improved efficiency in design will remain priorities for vehicle designers. In addition to fuel efficiency, reduced cost of components, including parts, assemblies, and subsystems, among others, is another priority for vehicle designers and manufacturers.

Unfortunately, many weight reduction implementations also result in a louder vehicle cabin. Customers desire a fuel-efficient vehicle that is relatively quiet, and therefore vehicle noise, vibration, and harshness (NVH) are also of increased importance in the design of vehicles. Soundproofing a vehicle improves both vehicle quality and improves the customer experience.

Further complicating improved fuel efficiency, vehicle designers and manufacturers are implementing reductions in lifecycle costs (e.g. carbon footprint, expense) including increasing the percentage of recycled content in parts by using more post-consumer recycled product and/or pre-consumer recycled product.

Some vehicle parts are manufactured from inexpensive resin (i.e. base or matrix material) polymers such as polypropylene. Material fillers (e.g. bio-materials, fibers, glass, talc) are added to the resin to improve material properties including dimensional capabilities, heat resistance, and stiffness. These material blends of resin and filler are traditional commercial solutions partially because the material blends are inexpensive while providing adequate structure. Unfortunately, these traditional commercial solutions lack desired NVH properties including sound attenuation and heat deflection.

Vehicle designers and manufacturers are striving to improve NVH performance while implementing smaller block (e.g. turbocharged gasoline and diesel) engines that generate more heat and vibration. These hotter engines improve fuel economy but require combinations of heat shields and NVH pads, which are added to address the shortcomings of these lower cost materials. However, heat shields and NVH pads add significant cost and weight to the vehicle.

Issues with current commercially viable materials include heat deflection and noise transmission. The heat deflection temperature of polypropylene is about 125° C. under a 1.8 MPa load. Often, parts are packaged near hot engine components requiring additional heat deflectors and/or thermal isolation to protect the parts from the elevated temperatures. The heat deflection temperature or heat distortion temperature (HDT, HDTUL, or DTUL) is the temperature at which a polymer or plastic sample deforms under a specified load. The HDT is often determined by either ASTM D648 or ISO 75. Current commercially viable material fillers, such as glass and talc, readily transmit sound to their surroundings. Current sound attenuators have shown limited commercial viability for low to medium vehicle production.

The present disclosure addresses these issues and other issues related to maintaining or improving vehicle lifecycle costs including expense, fuel efficiency, quality, recycled material content, and weight.

### SUMMARY

In one form of the present disclosure, a composite material is provided that comprises a recycled polypropylene material in an amount between 50 wt. % and 85 wt. %, a recycled tire rubber material in an amount between 2.0 wt. % and 30 wt. %, a heat stabilizer in an amount between 0.25 wt. % and 3.0 wt. %, a coupling agent in an amount between 1.0 wt. % and 5.0 wt. %, and reinforcements in an amount between 5.0 wt. % and 40 wt. %.

The reinforcements may be fibers selected from the group consisting of glass, carbon, and recycled carbon fibers.

In other forms, the composite material further comprises at least one of a flow enhancer in an amount between 0.01 wt. % and 2.0 wt. %, a UV stabilizer in an amount between 0.2 wt. % and 3.0 wt. %, a flame retardant, a color concentrate in an amount between 1.0 wt. % and 3.0 wt. %, and a chemical foaming agent in an amount between 0.5 wt. % and 3.5 wt. %.

In one particular form of the composite material, the recycled polypropylene material is about 71 wt. %, the recycled tire rubber material is about 5 wt. %, the heat stabilizer is about 0.75 wt. %, the coupling agent is about 1.5 wt. %, the reinforcements are glass fibers in an amount of 20 wt. %, and the color concentrate is about 1.5 wt. %.

Alternatively, in yet another form of the composite material of the present disclosure, the recycled polypropylene material is about 61 wt. %, the recycled tire rubber material is about 2.5 wt. %, the heat stabilizer is about 0.75 wt. %, the coupling agent is about 1.5 wt. %, the reinforcements are glass fibers in an amount of 35 wt. %, and the color concentrate is about 1.5 wt. %.

In still another form, the recycled polypropylene material is about 76 wt. %, the recycled tire rubber material is about 10 wt. %, the heat stabilizer is about 0.75 wt. %, the coupling agent is about 1.5 wt. %, the reinforcements are recycled carbon fiber in an amount of 10 wt. %, and the color concentrate is about 1.5 wt. %.

In yet another form, the recycled polypropylene material is about 65 wt. %, the recycled tire rubber material is about 15 wt. %, the heat stabilizer is about 0.75 wt. %, the coupling agent is about 1.5 wt. %, the reinforcements are glass fibers in an amount of 5 wt. % and recycled carbon fiber in an amount of 5 wt. %, and the color concentrate is of about 1.5 wt. %. The composite material further comprises a chemical foaming agent in an amount of about 6 wt. %.

At least one part is formed from the composite materials of the present disclosure, which includes a foam core.

In another form of the present disclosure, a composite material is provided that comprises recycled polypropylene material in an amount of about 71 wt. %, recycled tire rubber material in an amount of about 5 wt. %, a heat stabilizer in an amount of about 0.75 wt. %, a coupling agent in an amount of about 1.5 wt. %, a flow enhancer in an amount of about 0.03%, glass fiber reinforcements in an amount of 20 wt. % and a color concentrate in an amount of about 1.5 wt. %. A part is also formed from this composite material, which includes a foam core.

In yet another form of the present disclosure, a part is provided that comprises a foam core and a composite material covering the foam core. The composite material comprises a recycled polypropylene material in an amount between 50 wt. % and 85 wt. %, a recycled tire rubber material in an amount between 2.0 wt. % and 30 wt. %, a heat stabilizer in an amount between 0.25 wt. % and 3.0 wt. %, a coupling agent in an amount between 1.0 wt. % and 5.0 wt. % and reinforcements in an amount between 5.0 wt. % and 40 wt. %.

The foam core of the present disclosure may be formed by a microcellular molding process or a chemical foaming process. With the chemical foaming process, the composite material further comprises a chemical foaming agent in an amount of about 6 wt. %.

In one form of the part, the recycled tire rubber and the reinforcements align along outer walls of the part in a direction of material flow in a process that forms the foam core. Further, in one part, a color concentrate is used in an amount of about 1.5 wt. %.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A illustrates an exemplary cut pile carpet which is employed in a composite material according to the teachings of the present disclosure;

FIG. 1B illustrates an exemplary looped pile carpet which is employed in a composite material according to the teachings of the present disclosure;

FIG. 2 illustrates an exemplary method of recycling nylon carpet according to the teachings of the present disclosure;

FIG. 3 is a cross-section of an exemplary composite material and a foam core of a part according to the teachings of the present disclosure; and

FIG. 4 is a graph of exemplary melt flow indices (MFI) as a function of flow enhancers, according to the teachings of the present disclosure.

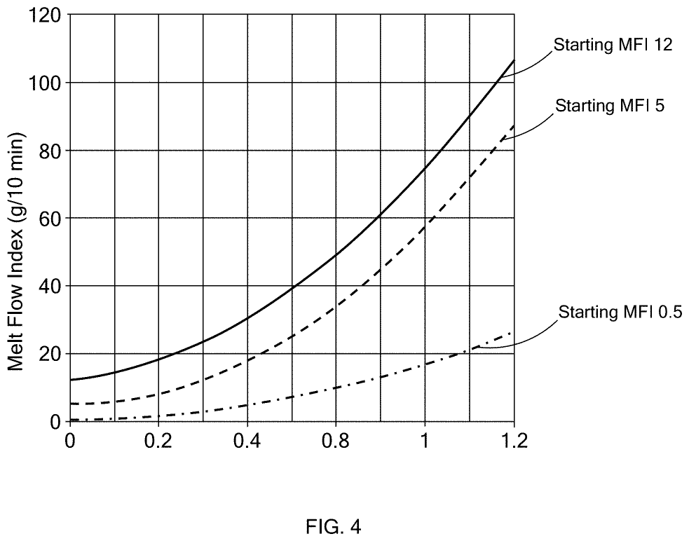

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

To address issues related to maintaining or improving vehicle lifecycle costs (e.g. environmental impact, expense, fuel efficiency, quality, recycled material content, and weight) the present disclosure provides a new composite material with an improved combination of lifecycle costs and material properties. This new composite material comprises polypropylene, rubber, structural fillers, and various additives and is compatible with a structural foam molding process.

Resins or Matrix Materials

Polypropylene is a crystalline, thermoplastic resin made by the polymerization of propylene (C₃H₆) and is moldable into various articles. Polypropylene is hard and tough, and resists moisture, oils, and vents, while withstanding temperatures up to about 170° C. The present disclosure employs both virgin polypropylene and recycled polypropylene.

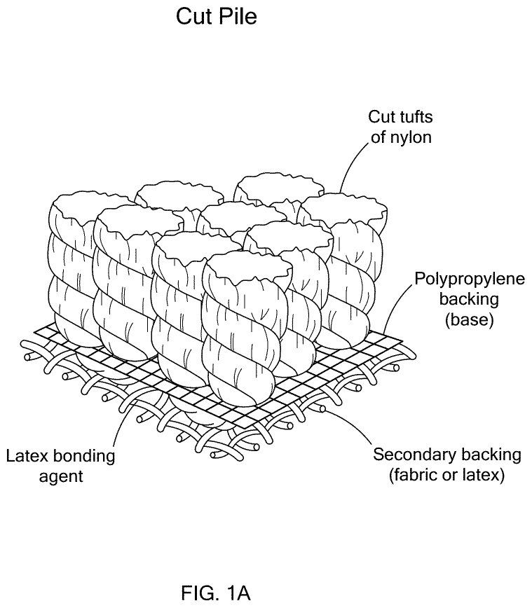

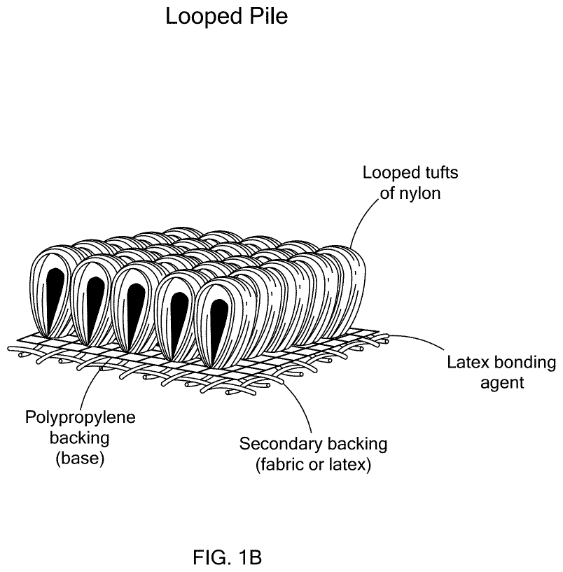

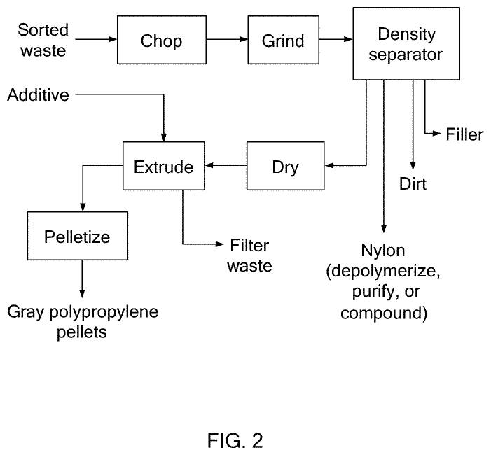

The inventors have found surprising success with a recycled polypropylene derived from the backing of nylon carpets, exemplified in the cut pile carpet of FIG. 1A and the looped pile carpet of FIG. 1B. To recycle nylon carpet, as shown in FIG. 2, the tufts of nylon (e.g., cut or looped tufts) are shaved from the primary polypropylene backing. The polypropylene backing, secondary backing, and latex bonding agents are chopped or segmented (about 1″ (25.4 mm)×about 1″ (25.4 mm)×backing thickness) and then ground into a coarse powder. The coarse powder is melted as the dirt and fillers are separated from the polypropylene by density. Remnant impurities in the melt are removed as the melt is extruded and filtered from the polypropylene. The cleansed, filtered, reclaimed, and recycled polypropylene is then pelletized.

Successful polypropylene integration into a composite material has been found with up to about 90 wt. % recycled polypropylene material, with an alternate range in an amount between about 50 wt. % and about 87 wt. % recycled polypropylene material. Specific compositions have achieved success at about 61 wt. %, about 65 wt. %, about 71 wt. %, and about 76 wt. % recycled polypropylene material.

Structural Reinforcements

The inventors have added at least one type of reinforcement (e.g., carbon, glass, basalt, among others), or a combination of reinforcements, to improve mechanical properties of the composite material of the present disclosure. The reinforcements may be in the form of fibers, which reinforce the resin in the composite material, mainly providing improved mechanical properties. The improved mechanical properties include dimensional stability, heat distortion temperature (HDT), flexural modulus (stiffness), tensile strength, and yield strength. Generally, the composite material of the present disclosure includes structural reinforcements in the range of up to about 50 wt. %, with an alternate range in an amount between about 5 wt. % and about 45 wt. % reinforcements, as described in greater detail below. Further, the reinforcements may be in the form of fibers or bubbles, among other forms.

Carbon fibers are employed in one form of the present disclosure to reduce weight but are generally more expensive. As the wt. % carbon fiber increases most material properties of the composite material also improve. Unfortunately, the addition of carbon fibers often reduces the ductility of the composite material. Further, carbon fiber is more expensive than glass fiber, but carbon fiber is more efficient at improving the material properties of the composite material than glass fibers. The expense of carbon fibers is mitigatable by using recycled carbon fiber. Composite material compositions of the present disclosure have achieved desired material properties at about 5 wt. % and about 10 wt. % recycled carbon fiber.

Glass fibers are employed in various forms of the present disclosure as described in greater detail below. As the wt. % glass fiber increases, most material properties of the composite material also improve. Unfortunately, the addition of glass fibers reduces the ductility of the composite material and also have the potential to affect the appearance of the composite material. While glass fibers are less expensive, recycled glass fibers can further reduce the expense. Composite material compositions of the present disclosure have achieved desired material properties at about 5 wt. %, about 20 wt. %, about 30 wt. %, and about 35 wt. % glass fiber. Further, the combination of about 5.0 wt. % glass fiber and about 5.0 wt. % carbon fiber also yielded desired material properties, as described in greater detail below.

Another structural filler that may be employed is basalt fiber. Basalt fiber is a material made from extremely fine fibers of basalt, which is composed of the minerals plagioclase, pyroxene, and olivine. Basalt fiber and glass fiber are similar, however, basalt fiber has improved material properties compared to glass fiber and is significantly less expensive than carbon fiber. Composite material compositions of the present disclosure have achieved desired material properties at about 5 wt. %, about 10 wt. % basalt fiber.

Additional Fillers/Additives

Rubber is employed according to the teachings of the present disclosure and is an inexpensive natural sound attenuator for at least low to medium frequency sounds. The rubber is a micronized rubber powder (MRP) created from recycled tires, often referred to as ASTM D5603-01. Tire rubber has the benefits of rubber in addition to increasing the heat resistance of matrix materials including polypropylene less expensively than virgin rubber.

MRP is a fine, dry, powdered elastomeric crumb rubber that is generally free of foreign particulates (e.g., metal, fiber), enabling its use in a wide range of advanced products. MRP is an inexpensive, high-performance, sustainable raw material that replaces oil- and rubber-based materials. MRP particle size distribution ranges from about 10 μm to 180 μm, with a significant proportion of MRP particles less than or equal to about 100 μm. The present disclosure desires an average particle size of 75 μm. Depending on the application, greater than or equal to about 1 wt. % MRP enables the present disclosure. Generally, the inventors have found that increases in the wt. % MRP enable improvements in composite material properties (e.g., heat resistance, NVH properties) and overall cost of the product while lowering the quantity of MRP filler as compared to conventional fillers. However, the inventors have found desirable results in the range of about 2 wt. % to about 15 wt. %. Generally, the composite material of the present disclosure has rubber in the range of up to about 40 wt. %, with an alternate range in an amount between about 2 wt. % and about 25 wt. % recycled tire rubber material. Composite material compositions of the present disclosure have achieved desired material properties at about 2.5 wt. %, about 5 wt. %, about 10 wt. %, and about 15 wt. % recycled tire rubber material.

Antioxidants or heat stabilizers are employed according to the teachings of the present disclosure, which generally inhibit oxidation during processing. Heat stabilizers act as melt processing stabilizers, improving heat stability and oxidation resistance. Polypropylene exposed to high heat, such as in the proximity to the engine compartment of a vehicle, is subject to oxidation. Oxidation leads to deterioration of material properties and discoloration. Various heat stabilizers including hindered phenolic antioxidants combined with thioester synergists combat oxidation in the composite material of the present disclosure. Generally, the composite material of the present disclosure has heat stabilizers in the range of up to about 11 wt. %, with an alternate range in an amount between about 0.15 wt. % and about 5.0 wt. % heat stabilizer. Composite material compositions of the present disclosure have achieved desired material properties in the range between about 0.25 wt. % and about 3.0 wt. %, at about 0.55 wt. %, about 0.75 wt. %, and about 0.9 wt. % heat stabilizer.

Colorants (e.g., color additives, coloring concentrates) are added to the composite material depending on the desired color for a given application. Commercially available polypropylene compatible colorants are appropriate. Generally, the composite material of the present disclosure has color concentrates in the range of up to about 12 wt. %, with an alternate range in an amount between about 1.0 wt. % and about 3.0 wt. % color concentrate. Composite material compositions of the present disclosure have achieved desired material properties at about 1.5 wt. %, about 2.0 wt. %, and about 2.25 wt. % color concentrate, which in one form is a black colorant, for example in an application of a heat shield or NVH pad.

Flame retardants are also contemplated as an optional additive for the composite material of the present disclosure, depending on the desired level of flame resistance for a given application. Flame retardant additives include: brominated halogen, chlorinated halogen, phosphorus based, or metal oxide (endothermic).

Foam Cores

Advantageously, the composite materials according to the present disclosure may be molded with a foam core in various structural foam molding processes. Both traditional and microcellular foaming technology enable the use of foam cores with the composite materials of the present disclosure.

With a chemical foaming process, chemical foaming agents further enhance the sound attenuation properties of MRP and rubbers reducing the cost and weight of the final product. Foaming creates minute voids that entrap sound and thus reduces sound transmission and improving sound attenuation.

Microcellular molding technology and processes enable a foam core within the walls of the composite material. Microcellular foam (i.e. microcellular plastics) are a form of manufactured plastic, specially fabricated to contain billions of tiny bubbles less than about 50 μm in size (regularly from about 0.02 to about 100 μm). Microcellular foams are formed by dissolving gas under high pressure into various polymers, relying on “thermodynamic instability phenomena” to cause the uniform arrangement of the gas bubbles, otherwise known as nucleation. Methods of molding a micro-cellular core in a thin wall injection molded part include using a foaming agent that is compatible with polypropylene materials and molding the part in a process such as MuCell® injection molding process. Generally, this process introduces gas (e.g., Nitrogen) in a supercritical state and dissolves the gas under high pressure into the base polymer, or the polypropylene.

The inventors experimentally introduced up to about 16 wt. % nitrogen into the composite material, reducing the density of the resin and the quantity of resin used by about 16% when using injection molding and blow molding methods, with negligible or nominal affects to the surface quality of the composite material. Depending on the application, surface degradation is allowable and more foam (>16 vol. % N) is permissible. Generally, the composite material of the present disclosure has chemical foaming agents in the range of up to about 16 wt. %, with an alternate range in an amount between about 0.5 wt. % and about 9.5 wt. % chemical foaming agents. Composite material compositions of the present disclosure have also achieved desired material properties at about 1.0 wt. %, about 3.5 wt. %, and about 6 wt. % chemical foaming agent.

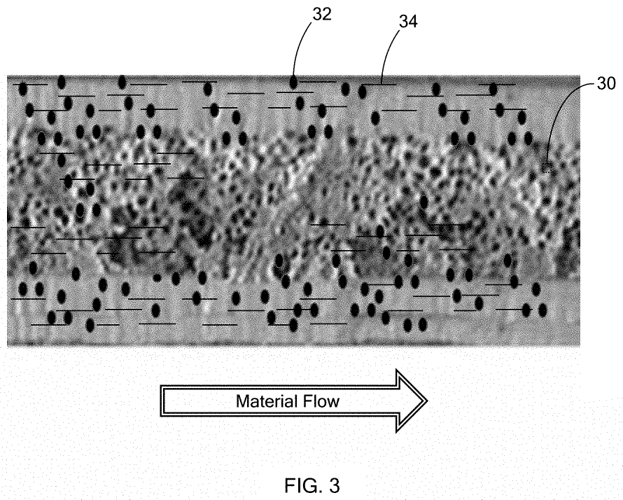

Now referring to FIG. 3, a cross-section of an exemplary part having the composite material and a foam core of the present disclosure illustrates the microcellular foam core 30, MRP 32, and fibers 34. Both the MRP 32 and the fibers 34 align along the outer walls of the part in the direction of material flow forming a noise blocking NVH barrier. Together, the microcellular foam core 30, MRP 32, and fibers 34 enhance the performance of polypropylene, providing both structure and an NVH barrier.

Further, when injection molding with foaming agents, the “pack and hold” phase is replaced with a cell growth phase. The lower stress “foamed” parts have enhanced dimensional stability and substantially reduce warpage. Cell growth reduces or minimizes sink marks. Additional advantages from foaming include reduced expenses and improved design freedom. The reduced expenses include, but are not limited to, faster molding cycle time, increased part yields, reduced resin consumption, and reduced tonnage. The improved design freedom includes, but is not limited to, improved co-location of material to analytical models, improved dimensional stability, reduced warpage, thin to thick wall flow, and wall thickness ratios of up to about 1 to 1 (1:1)

Flow enhancers for controlled viscosity suppression (e.g. hydrogen peroxide) are added to improve the viscosity (melt flow) of the melt and facilitate down-gaging (i.e. reduction of part thickness). These fatty acid derivatives fracture the polymer chain of the polypropylene molecules and increasing melt flow of the material and also act as mold release agents. Melt flow rate indirectly measures molecular weight, with higher melt flow rates corresponding to lower molecular weights. Concurrently, melt flow rate is a measure of the ability of the material melt to flow under pressure. Melt flow rate is inversely proportional to the viscosity of the melt at the conditions of the test, note the viscosity for any such material depends on the applied force.

The melt flow index (MFI) is a measure of the ease of flow of the melt of a polymer. It is defined as the mass of polymer, in grams, flowing in ten minutes through a capillary of a specific diameter and length by a pressure applied via prescribed alternative gravimetric weights for alternative prescribed temperatures. MFI measurements are described in both ASTM D1238 and ISO 1133. For the present disclosure, the desired MFI is 20 (g/10 min). To determine the desired wt. % of processing agent to add to the composite material, the inventors measured the initial MFI of the resin material. Recycled carpet polypropylene has a low MFI of about 0.5.

Referring to FIG. 5, the composite material of the present disclosure has flow enhancers in the range of up to about 10 wt. % to significantly improve viscosity and toughness of the polypropylene, with an alternate range in an amount between about 0.01 wt. % and about 2 wt. % flow enhancers. Composite material compositions of the present disclosure have achieved desired material properties at about 0.03 wt. %, about 0.75 wt. %, about 1.1 wt. %, and about 1.2 wt. % flow enhancer.

Polymer coupling agents (tie layer resins), such as maleic anhydride grafted polypropylene (MAPP), are employed in some forms of the present disclosure to enhance the impact properties of the composite material. The MAPP coats the material fillers and increases the bond strength between the fiber fillers. Generally, the composite material of the present disclosure has coupling agents in the amount of up to about 5 wt. %, with an alternate range in an amount between about 1.0 wt. % and about 5.0 wt. % coupling agent. Composite material compositions of the present disclosure have achieved desired material properties at about 1.25 wt. %, about 1.5 wt. %, and about 2 wt. % coupling agent.

Ultraviolet (UV) light stabilizers are added to the composite material depending on the desired level of UV stability for a given application. Hindered amine light stabilizers and high molecular weight hindered amine light stabilizers having minimal interaction with co-additives are highly effective in polypropylene containing colorants. Other UV inhibitors (e.g. UV absorbers, benzophenones, and benzotriazoles) compatible with and added to the polypropylene will also achieve desired properties. Generally, the composite material of the present disclosure has UV stabilizers in the amount of up to about 5 wt. %, with an alternate range in an amount between about 0.2 wt. % and about 3.0 wt. % UV stabilizers. Composite material compositions of the present disclosure have achieved desired material properties at about 1.25 wt. %, about 1.5 wt. %, and about 1.75 wt. % UV stabilizers.

The following specific compositions are given to illustrate the unique composite material, properties, and use of composite materials prepared according to the teachings of the present disclosure and should not be construed to limit the scope of the disclosure. Those skilled in the art, in light of the present disclosure, will appreciate that slight changes can be made in the specific compositions to achieve equivalents that obtain alike or similar results without departing from or exceeding the spirit or scope of the present disclosure.

Exemplary compositions according to experimental testing are found below in Tables 1 and 2. Table 1 includes the composition of a baseline/comparative composition against four (4) compositions/formulations (A through D) according to the teachings of the present disclosure, and Table 2 includes the mechanical properties of each of these compositions.

TABLE 1
Exemplary Compositions

| | | COMP. A | COMP. B | COMP. C | COMP. D |
|---|---|---|---|---|---|
| MATERIALS | BASELINE (wt. %) | (wt. %) | (wt. %) | (wt. %) | (wt. %) |
| Virgin | 66.22% | 0% | 0% | 0% | 0% |
| Polypropylene | | | | | |
| Recycled | 0% | 60.72% | 71.22% | 76.22% | 65.22% |
| Polypropylene | | | | | |
| Recycled Tire | 0% | 2.5% | 5% | 10% | 15% |
| Rubber | | | | | |
| Low Density | 1.50% | 1.50% | 1.50% | 1.50% | 1.50% |
| Color | | | | | |
| Concentrate | | | | | |
| Stabilizer (Heat) | 0.75% | 0.75% | 0.75% | 0.75% | 0.75% |
| Coupling Agent | 1.50% | 1.50% | 1.50% | 1.50% | 1.50% |
| Flow Enhancer | 0.03% | 0.03% | 0.03% | 0.03% | 0.03% |
| Glass | 30% | 35% | 20% | 0% | 5% |
| Recycled | 0% | 0% | 0% | 10% | 5% |
| Carbon Fiber | | | | | |
| Chemical | 0% | 0% | 0% | 0% | 6% |
| Foaming Agent | | | | | |

TABLE 2
Exemplary Material Properties

| MATERIAL | | | | | |
|---|---|---|---|---|---|
| PROPERTIES | BASELINE | COMP. A | COMP. B | COMP. C | COMP. D |
| Density (g/cm³) | 1.21 | 1.07 | 1.18 | 1.003 | 0.98 |
| Flex Modulus (MPa) | 3,500 | 3,500 | 5,240 | 5,500 | 3,500 |
| Wall Thickness | 3 | 3 | 3 | 2.5 | 2.5 |
| (mm) | | | | | |
| HDT (° C.) | ≤130 | ≤130 | ≤130 | ≤130 | ≤130 |
| Impact - Notched | 5.3 | 5.75 | 4.62 | TBD | TBD |
| IZOD (KJ/m²) | | | | | |
| Elongation (%) | 3 | 2.4 | 2.3 | TBD | TBD |
| Tensile Strength | 46 | 52.6 | 67.7 | TBD | TBD |
| (MPa) | | | | | |
| Weight Saving - | 0% | 12% | 3% | 17% | 19% |
| Material (%) | | | | | |
| Weight Saving - | 0% | 10% | 10% | 10% | 10% |
| Process (%) | | | | | |
| Total Weight Saving | 0% | 22% | 13% | 27% | 29% |
| Noise Reduction | 0% | 15-20% | 5-10% | 20-30% | 30-35% |
| (%) | | | | | |

As shown, the improvements in mechanical properties with respect to the baseline compositions is remarkable and includes lower density while reducing cost and NVH effects. Further, the mechanical properties may vary +/−5% while remaining within the scope of the present disclosure. This may be due to material batch and manufacturing variations, among other factors and design specifications. This careful balance of increased mechanical properties, lighter weight, and material savings has been achieved by the inventors through extensive testing and analysis of surprising results.

Accordingly, a novel composite material has been developed by the inventors that utilizes recycled constituents to significantly reduce the density of the composite material while delivering a less expensive solution to improve the NVH and strength of composite materials at an affordable cost. The inventors were surprised to discover that the use of additives, recycled materials, and the addition of small amounts of material fillers recouped the degradation of properties seen when substituting glass bubbles for talc. Therefore, the teachings of the present disclosure yield a low-density material that is lower cost than existing state of the art materials. Further, the amount of each constituent of the novel composite material may vary +/−10% while remaining within the scope of the present disclosure.

An exemplary application of the new composite material is the extension dash panel of a vehicle. Extension dash panels are removable structural components located under the cowl leaf screen of a vehicle and serve numerous purposes including providing the attaching structure for the cowl leaf screen and channeling fluids around the vehicle. The extension dash panel channels air with respect to (i.e. away from, around, and towards) the vehicle cabin (i.e. passenger compartment) heating, ventilation, and air conditioning (HVAC) system. Further, the extension dash panel channels water with respect to the passenger compartment HVAC system. Moreover, the extension dash panel also inhibits heat and noise generated by the engine compartment from affecting the passenger compartment.

As used herein, a “structural component” should be construed to mean a part or component that carries structural loads (e.g., tension, compression, bending), and transfers those loads to and from adjacent components, versus a part that is merely used as a fairing or cover, and which carries no significant loads. One skilled in the art of vehicle design understands this distinction.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. this modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A composite material comprising:
a recycled polypropylene material in an amount between 50 wt. % and 85 wt. %;
a recycled tire rubber material in an amount between 2.0 wt. % and 30 wt. %;
a heat stabilizer in an amount between 0.25 wt. % and 3.0 wt. %;
a coupling agent in an amount between 1.0 wt. % and 5.0 wt. %; and
reinforcements in an amount between 5.0 wt. % and 40 wt. %.

2. The composite material according to claim 1, wherein the reinforcements are fibers are selected from the group consisting of glass and carbon.

3. The composite material according to claim 2, wherein the reinforcements are recycled carbon fibers.

4. The composite material according to claim 1 further comprising a flow enhancer in an amount between 0.01 wt. % and 2.0 wt. %.

5. The composite material according to claim 1 further comprising a UV stabilizer in an amount between 0.2 wt. % and 3.0 wt. %.

6. The composite material according to claim 1 further comprising a flame retardant.

7. The composite material according to claim 1 further comprising color concentrate in an amount between 1.0 wt. % and 3.0 wt. %.

8. The composite material according to claim 1 further comprising a chemical foaming agent in an amount between 0.5 wt. % and 3.5 wt. %.

9. The composite material according to claim 1, wherein:
the recycled polypropylene material is about 71 wt. %;
the recycled tire rubber material is about 5 wt. %;
the heat stabilizer is about 0.75 wt. %;
the coupling agent is about 1.5 wt. %;
the reinforcements are glass fibers in an amount of 20 wt. %; and
further comprising a color concentrate in an amount of about 1.5 wt. %.

10. The composite material according to claim 1, wherein:
the recycled polypropylene material is about 61 wt. %;
the recycled tire rubber material is about 2.5 wt. %;
the heat stabilizer is about 0.75 wt. %;
the coupling agent is about 1.5 wt. %;
the reinforcements are glass fibers in an amount of 35 wt. %; and
further comprising a color concentrate in an amount of about 1.5 wt. %.

11. The composite material according to claim 1, wherein:
the recycled polypropylene material is about 76 wt. %;
the recycled tire rubber material is about 10 wt. %;
the heat stabilizer is about 0.75 wt. %;
the coupling agent is about 1.5 wt. %;
the reinforcements are recycled carbon fiber in an amount of 10 wt. %; and
further comprising a color concentrate in an amount of about 1.5 wt. %.

12. The composite material according to claim 1, wherein:
the recycled polypropylene material is about 65 wt. %;
the recycled tire rubber material is about 15 wt. %;
the heat stabilizer is about 0.75 wt. %;
the coupling agent is about 1.5 wt. %;
the reinforcements are glass fibers in an amount of 5 wt. % and recycled carbon fiber in an amount of 5 wt. %; and
further comprising:
a color concentrate in an amount of about 1.5 wt. %; and
a chemical foaming agent in an amount of about 6 wt. %.

13. A part formed from the composite material according to claim 1, wherein the part comprises a foam core.

14. A composite material comprising:
recycled polypropylene material in an amount of about 71 wt. %;
recycled tire rubber material in an amount of about 5 wt. %;
a heat stabilizer in an amount of about 0.75 wt. %;
a coupling agent in an amount of about 1.5 wt. %;
a flow enhancer in an amount of about 0.03%;
glass fiber reinforcements in an amount of 20 wt. %; and
a color concentrate in an amount of about 1.5 wt. %.

15. A part formed from the composite material according to claim 14, wherein the part comprises a foam core.

16. A part comprising:
a foam core; and
a composite material covering the foam core, the composite material comprising:
a recycled polypropylene material in an amount between 50 wt. % and 85 wt. %;
a recycled tire rubber material in an amount between 2.0 wt. % and 30 wt. %;
a heat stabilizer in an amount between 0.25 wt. % and 3.0 wt. %;
a coupling agent in an amount between 1.0 wt. % and 5.0 wt. %; and
reinforcements in an amount between 5.0 wt. % and 40 wt. %.

17. The part according to claim 16, wherein the foam core is formed by a microcellular molding process.

18. The part according to claim 16, wherein the foam core is formed by a chemical foaming process, and the composite material further comprises a chemical foaming agent in an amount of about 6 wt. %.

19. The part according to claim 16, wherein the recycled tire rubber and the reinforcements align along outer walls of the part in a direction of material flow in a process that forms the foam core.

20. The part according to claim 16 further comprising a color concentrate in an amount of about 1.5 wt. %.
